(19) United States
(12) Patent Application Publication
(10) Pub. No.: US 2012/0296487 A1
(43) Pub. Date: Nov. 22, 2012

(54) OCCUPANCY SENSING WITH VACATE INPUT

(75) Inventors: Richard A. Leinen, Wilsonville, OR (US); Robert L. Hick, Newberg, OR (US); Thomas W. Leonard, Tualatin, OR (US)

(73) Assignee: LEVITON MANUFACTURING CO., INC., Melville, NY (US)

(21) Appl. No.: 13/110,712

(22) Filed: May 18, 2011

(51) Int. Cl. G06F 1/26

(52) U.S. Cl. 700/296; 700/295

(57) ABSTRACT

An occupancy sensing system includes a vacate input to cause the system to turn lights on without substantial delay when a monitored space becomes occupied after turning the load off in response to the vacate input. A special vacate input may be eliminated by determining, in response to a manual-off input, if the space has been vacated. A dead time may be included to prevent the lights from being turned back on by movement that is detected as occupants vacate the monitored space after pressing a vacate or manual-OFF button.

### BACKGROUND OF THE INVENTION

FIG. 1 illustrates the operation of a prior art occupancy sensor. Various states, events and actions of the system are shown as time progresses along the horizontal axis. The symbol ↓ in the OCC DET line indicates when a signal from a sensor circuit indicates that occupancy has been detected. Various sensors may be used including passive infrared (PIR), ultrasound (U/S), audio, video, microwave, etc. The line DELAY TIMER represents the state of a delay timer which is reset to a maximum value of 100 percent each time occupancy is detected, then counts down to a minimum (cleared) value of zero percent. The line OCCUPIED indicates the state of a binary signal within the occupancy sensor that is used for logical determinations of whether to turn the lights on or off. The line LIGHTS indicates the state of the lights where a solid bar indicates that the lights are on.

Some occupancy sensors also include a manual on/off button that can be used to override the occupancy sensor and manually toggle the state of the lights. Thus, the sensor circuit and manual on/off button operate independently of each other. The symbol ↓ in the MANUAL ON/OFF line indicates when a user presses a manual on/off button.

Prior to time t0, the DELAY TIMER is at zero, the OCCUPIED signal line is low, and the lights are off. In this state, the system waits for the OCC DET signal to indicate that occupancy is detected. At time t0, occupancy is detected, which may be caused, for example, by an occupant entering the space. This causes the system to turn the lights on, reset DELAY TIMER to 100 percent, and activate the OCCUPIED signal line.

DELAY TIMER continues to decrease until time t1 when the sensor circuit detects occupancy again which may be caused, for example, by an occupant moving. This causes the system to reset DELAY TIMER to 100 percent. Another occupancy event is detected at time t2 which again causes the system to reset DELAY TIMER to 100 percent. At time t3, DELAY TIMER has decreased to zero, the OCCUPIED signal line is deactivated, and the lights are turned off.

The purpose of the delay timer is to prevent the system from turning the lights off while an occupant is still present in the monitored space but no motion is detected. Most sensors used for occupancy detection generally respond to motion by the occupant. When an occupant is present in a monitored space, there may be some periods of time during which the occupant is not moving, and therefore, the sensing circuit does not detect the occupant. If the lights were turned off as soon as the occupant stopped moving, the lights would frequently turn on and off as the occupant alternates between moving and standing still, even though the monitored space is continuously occupied. Thus, a delay timer is used to prevent the lights from turning off until no occupancy is detected for the entire time-out delay period since this is more likely to provide an accurate indication that the monitored space is actually unoccupied.

It should be noted that the system only turns the lights on in response to an occupancy event if the OCCUPIED signal line is low. Thus, at time t0, the system turns the lights on because the OCCUPIED signal line is low, but at times t1 and t2, the system does not attempt to turn the lights on because the OCCUPIED signal line is high which generally, but not always, indicates that the lights are already on.

At time t4, OCC DET indicates that occupancy is sensed which again causes the system to turn the lights on, reset DELAY TIMER to 100 percent, and activate the OCCUPIED signal line.

At time t5, a user presses the MANUAL ON/OFF button which causes the system to force the lights off. In order to press the MANUAL ON/OFF button, the user is likely to have moved enough to cause the sensor circuit to detect occupancy, and therefore, DELAY TIMER is reset to 100 percent. The OCCUPIED signal line remains high.

In this state the lights stay off, regardless of whether occupancy is detected by the sensor circuit, until DELAY TIMER decreases to zero at time t9. Even though occupancy is detected at times t6, t7 and t8, the system does not turn the lights on because the OCCUPIED signal line is high. This state may be useful, for example, to turn off the lights for an audio/video presentation where the lights need to remain off even though the space is occupied and the occupants may be moving.

A problem with the prior art system, however, may occur when a user returns to the room shortly after manually turning the lights off using the MANUAL ON/OFF button while leaving the room. For example, if the user presses the MANUAL ON/OFF button at time t5 because the user is leaving the room, DELAY TIMER is reset to 100 percent, and the lights stay off, regardless of whether occupancy is detected by the sensor circuit, until after DELAY TIMER decreases to zero. However, if the user re-enters the room at any time before the DELAY TIMER decreases to zero (for example, between t6 and t9), the lights remain off, even though the sensor circuit detects an occupied condition because DELAY TIMER is reset to 100 percent every time occupancy is detected, thereby causing the OCCUPIED line to remain high until t9. Thus, the user must turn the lights on manually by pressing the MANUAL ON/OFF button if the user re-enters the room before time t9.

### SUMMARY OF THE INVENTION

An occupancy sensing system may include an occupancy sensor to sense the occupied state of a space and control a load in response to the occupied state of the space, a vacate input to enable an occupant to indicate an intention to vacate the space, and vacate logic perform a vacate sequence in response to the vacate input.

The vacate input may include a dedicated vacate input. The vacate input may include a sequence of actions performed on a multi-purpose input. The sequence of actions may include a double actuation. The multi-purpose input may include a switch. The vacate input may include a message received on a communication network. The vacate input may include a reboot of the system. The vacate sequence may include switching a load to an unoccupied state, and may further include clearing a delay timer in the controller, and or delaying for a time period to allow an occupant to vacate the space. The vacate logic may return the load to an occupied state without substantial delay when the space becomes occupied again.

The system may include a power pack arranged to supply power to the occupancy sensor and switch power to the load in response to the controller. The system may further include a communication network coupled to the power pack, and an input device coupled to the communication network and adapted to transmit a vacate command to the power pack. The power pack may adapted to temporarily turn off the power supply to the controller in response to the vacate command.

An occupancy sensing system may include an occupancy sensor to sense the occupied state of a space and control a load in response to the occupied state of the space, and a vacate input to enable an occupant to indicate an intention to vacate the space, where the vacate logic is adapted to determine, in response to a manual input, if the space has been vacated. The manual input may include a manual-off input. The vacate logic may be adapted to determine if the space has been vacated by delaying during a first time period to allow an occupant to vacate the space. The vacate logic may determine if the space has been vacated by monitoring the space during a second time period following the first time period. The vacate logic may switch the load to an unoccupied state in response to the manual-off input, and return the load to the occupied state without substantial delay when the space becomes occupied again.

A method may include sensing the occupied state of a space, controlling a load in response to the occupied state of the space, turning the load off in response to a vacate input, and turning the load on without substantial delay when the space becomes occupied after turning the load off in response to the vacate input. The vacate input may be generated by determining if the space has been vacated in response to a manual-off input.

### BRIEF DESCRIPTION OF THE DRAWINGS

FIG. 1 illustrates the operation of a prior art occupancy sensor.

FIG. 2 illustrates an embodiment of a method for operating an occupancy sensor according to some inventive principles of this patent disclosure.

FIG. 3 illustrates an embodiment of an occupancy sensing system according to some inventive principles of this patent disclosure.

FIG. 4 illustrates an exemplary embodiment of an occupancy sensing system according to some inventive principles of this patent disclosure.

FIG. 5 illustrates another exemplary embodiment of an occupancy sensing system according to some inventive principles of this patent disclosure.

FIG. 6 illustrates another exemplary embodiment of an occupancy sensing system according to some inventive principles of this patent disclosure.

FIG. 7 illustrates another exemplary embodiment of an occupancy sensing system according to some inventive principles of this patent disclosure.

FIG. 8 illustrates another embodiment of an occupancy sensing system according to some inventive principles of this patent disclosure.

FIG. 9 illustrates a user input for an example embodiment of a five-button dimming controller having a vacate input according to some inventive principles of this patent disclosure.

FIG. 10 illustrates another exemplary embodiment of an occupancy sensing system according to some inventive principles of this patent disclosure.

FIG. 11 illustrates an exemplary physical embodiment of an occupancy sensing system according to some inventive principles of this patent disclosure.

FIG. 12 illustrates an embodiment of such a method according to some inventive principles of this patent disclosure.

FIG. 13 illustrates another exemplary embodiment of an occupancy sensing system according to some inventive principles of this patent disclosure.

### DETAILED DESCRIPTION

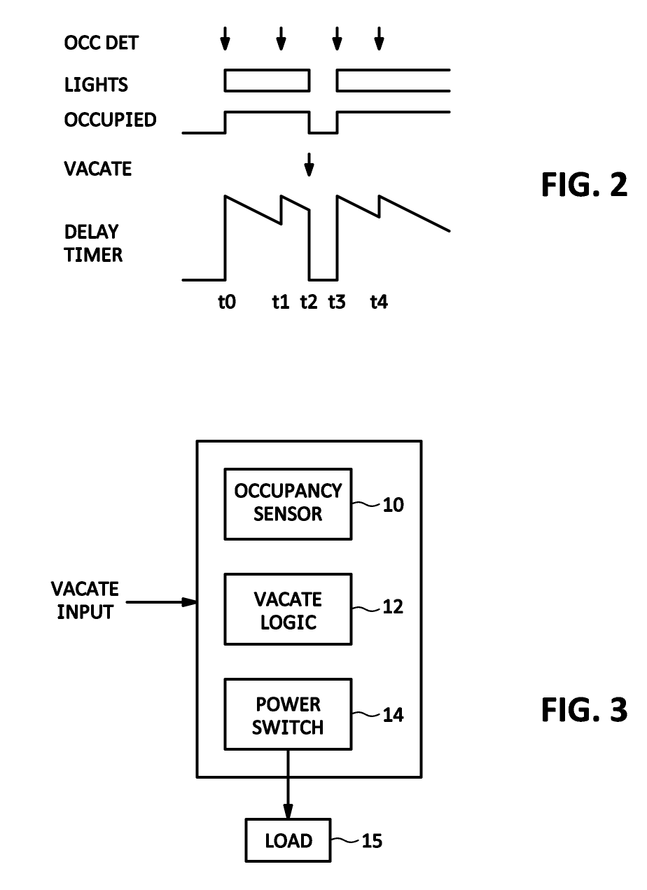

FIG. 2 illustrates an embodiment of a method for operating an occupancy sensor according to some inventive principles of this patent disclosure. The embodiment of FIG. 2 utilizes a VACATE input which enables a user to manually turn off the lights (or other load) and notify the occupancy sensing system that the monitored space is being vacated. The VACATE input may be implemented, for example, with a pushbutton switch.

Prior to time t0, the lights (or other load) are off and DELAY TIMER is at zero. At time t0, occupancy is sensed which causes the system to turn the lights (or other load) on, reset DELAY TIMER to 100 percent, and activate the OCCUPIED signal line. DELAY TIMER continues to decrease until time t1 when the sensor detects occupancy again. This causes the system to reset DELAY TIMER.

At time t2, a user provides a vacate input. Rather than resetting DELAY TIMER in response to the vacate input, however, the system clears DELAY TIMER. The system also deactivates the OCCUPIED line and turns the lights off. With DELAY TIMER cleared, the system is ready to turn the lights back on as soon as occupancy is detected again as shown, for example, at time t3.

Alternatively, rather than clearing DELAY TIMER, the system may set DELAY TIMER to a low value that inhibits turning the lights back on in response to sensing occupancy for a few seconds, e.g., 2-5 seconds, to enable any occupants to leave the monitored space after providing the vacate input to the system.

FIG. 3 illustrates an embodiment of an occupancy sensing system according to some inventive principles of this patent disclosure. The embodiment of FIG. 3 may be used, for example, to implement the method of FIG. 2. The system of FIG. 3 includes an occupancy sensor 10 to monitor a space, and a power switch 14 to control one or more electrical loads 15 in response to an occupancy signal from the occupancy sensor 10. The system of FIG. 3 also includes vacate logic 12 to process a vacate signal which enables a user to initiate a vacate sequence. A vacate sequence is a sequence of actions that includes switching one or more loads to an unoccupied state, i.e., a state commensurate with an unoccupied state of the monitored space. A vacate sequence may also include actions to enable occupants of the space to vacate the space without returning the one or more loads to the occupied state before the occupants have actually vacated the space. A vacate sequence may further include actions to enable returning the one or more loads to the occupied state without substantial delay when the space becomes occupied again.

The system of FIG. 3 may be embodied in any suitable physical form. For example, in some embodiments, the occupancy sensor 10 may be a separate assembly such as a ceiling or wall-mount unit, while the power switch 14 is implemented as part of a power pack that supplies low-voltage power to the occupancy sensor 10 and controls the power switch 14 in response to the occupancy signal. In other embodiments, the occupancy sensor 10 and power switch 14 may all be housed in a wiring device such as a wall switch.

Any suitable sensing technology may be used for the occupancy sensor 10 such as PR, ultrasound, audio, video, microwave, etc. The vacate logic 12 may be implemented by any means now known or hereafter developed including, for example, with analog or digital hardware, software, firmware, or any suitable combination thereof. The vacate logic 12 may be implemented completely within the occupancy sensor, completely within a power pack that includes the power switch, or distributed between the occupancy sensor and power pack. In other embodiments, the vacate logic 12 may be implemented completely or partially in the form of hardwiring between the occupancy sensor and a power pack.

The vacate input 12 may be implemented as a physical input, or in any other form such as a sequence of one or more key presses, a command or message received through a communication network or remote control, etc. If implemented in physical form such as a pushbutton switch, the vacate input 12 may be a separate, dedicated input or combined with another physical input device that performs other functions. The vacate input 12 can also be generated internally, for example, by determining that the monitored space has been vacated in response to an existing manual-off input.

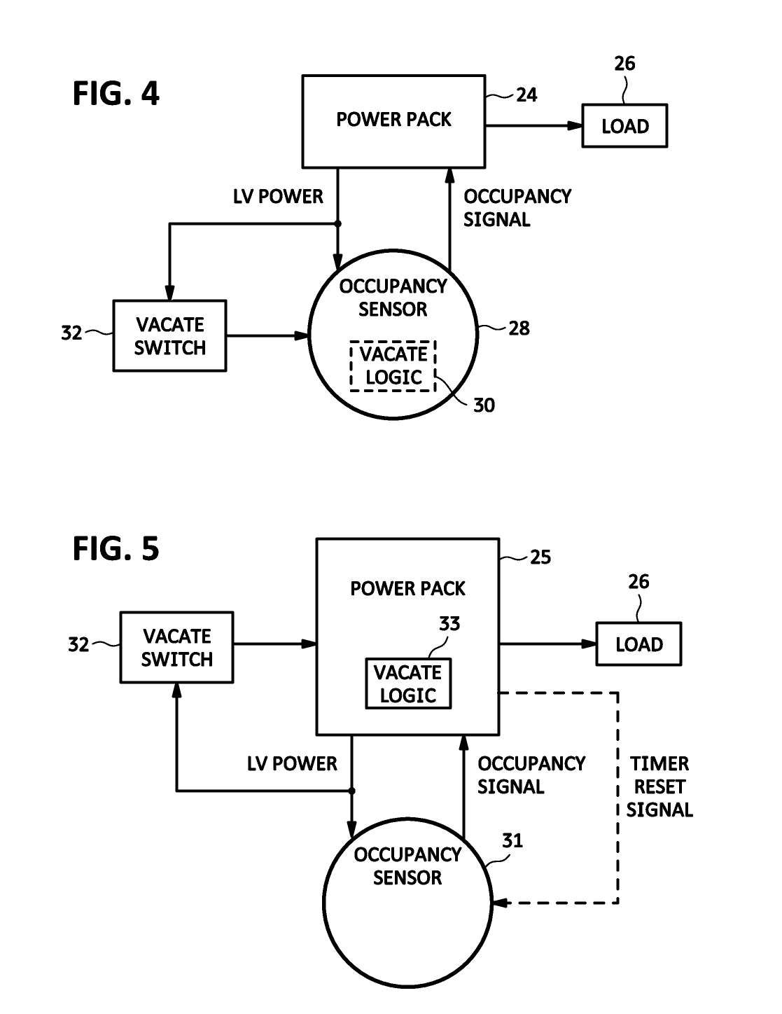

FIG. 4 illustrates an exemplary embodiment of an occupancy sensing system according to some inventive principles of this patent disclosure. The embodiment of FIG. 4 includes a power pack 24 that controls power to a load 26 (such as for example, a light, etc.) in response to an occupancy signal it receives from an occupancy sensor 28. The power pack 24 also provides low-voltage power to the occupancy sensor 28. The occupancy sensor 28 includes vacate logic 30 to perform a vacate sequence in response to a signal from a vacate switch 32. The vacate switch 32 is preferably connected between the low-voltage power from the power pack 24 and a dedicated vacate input in the occupancy sensor 28. Thus, the vacate switch 32 may provide a low-voltage, e.g., 24 VDC, input directly to the dedicated vacate input in the occupancy sensor 28. The vacate logic 30 in the occupancy sensor 28 can then implement a vacate sequence such as the one described and illustrated in connection with FIG. 2 by controlling the OCCUPIED line in response to the vacate input.

FIG. 5 illustrates another exemplary embodiment of an occupancy sensing system according to some inventive principles of this patent disclosure. The embodiment of FIG. 5 is similar to the embodiment of FIG. 4 in that it includes a power pack 25 that controls power to a load 26 in response to an occupancy signal it receives from an occupancy sensor 31, and provides low-voltage power to the occupancy sensor 31. In the embodiment of FIG. 5, however, the vacate logic 33 is located in the power pack 25, and the vacate switch 32 is preferably connected between the low-voltage power from the power pack 25 and a dedicated vacate input on the power pack. Thus, the vacate switch 32 may provide a low-voltage, e.g., 24 VDC, input directly to the dedicated vacate input on the power pack 25. The vacate logic 33 in the power pack 25 can then implement a vacate sequence by controlling the load 26 in response to both the dedicated vacate input and the occupancy signal 31. To facilitate clearing the delay timer in the occupancy sensor 31 when a vacate event occurs, a dedicated timer clear connection may be hard wired between the power pack 25 and the occupancy sensor 31.

Alternatively, the power pack 25 may cycle the low-voltage power to the occupancy sensor 31, thereby resetting the occupancy sensor 31 to a power-up state in which the occupancy sensor 31 is ready to assert the occupancy signal in response to detecting an occupant immediately after power-up. Such an implementation may or may not require modification to the occupancy sensor 31 to achieve the correct power-up state if an existing occupancy sensor 31 is used. If the occupancy sensor 31 is configured to clear the DELAY TIMER upon rebooting, then it is capable of implementing a vacate sequence because it would be ready to turn the load back on as soon as it detects occupancy after rebooting. The duration of the time period during which the power pack 25 disables power to the occupancy sensor 31 may be set to provide a dead time during which occupants may vacate the monitored space after providing the vacate input. A potential advantage of this technique is that it may enable the implementation of vacate functionality with an existing occupancy sensor 31 that clears its DELAY TIMER at power up, or may be modified to clear its DELAY TIMER at power up with a simple firmware or software upgrade.

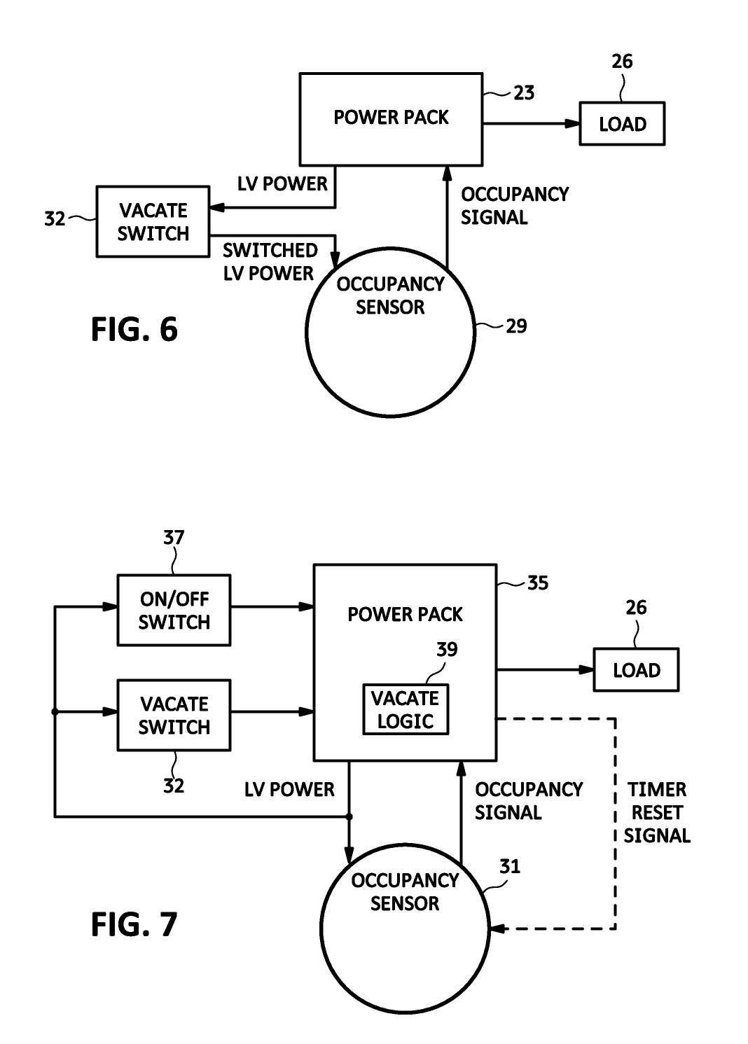

FIG. 6 illustrates another exemplary embodiment of an occupancy sensing system according to some inventive principles of this patent disclosure. The embodiment of FIG. 6 is also similar to the embodiment of FIG. 4 in that it includes a power pack 23 that controls power to a load 26 in response to an occupancy signal it receives from an occupancy sensor 29, and provides low-voltage power to the occupancy sensor 29. However, in the embodiment of FIG. 6, the vacate logic is essentially implemented in the form of hard wiring between the power pack 23 and the occupancy sensor 29. Specifically, the vacate switch 32 interrupts the low-voltage power from the power pack 23 to the occupancy sensor 29, thereby resetting the occupancy sensor 29 to a power-up state in which the occupancy sensor 29 is ready to assert the occupancy signal in response to detecting an occupant immediately after power-up. As with the embodiment of FIG. 5, such an implementation may or may not require modification to the occupancy sensor 29 to achieve the correct power-up state if an existing occupancy sensor 29 is used.

A MANUAL OFF OR MANUAL ON/OFF button may be added to any of the embodiments of FIGS. 4-6. An example is shown in FIG. 7 which is similar to the embodiment of FIG. 5, but includes a MANUAL ON/OFF button 37 that provides an ON/OFF input to a dedicated input on the power pack 35. If the MANUAL ON/OFF button 37 is pressed, vacate logic 39 in the power pack 35 toggles the state of the load 26, but allows the occupancy sensor 31 to continue its normal operation. If the vacate switch 32 is pressed while the load 26 is in the on state, the vacate logic 39 switches the load 26 off and clears the delay timer counter in the occupancy sensor 31, either through a dedicated TIMER CLEAR input, or by cycling the power to the occupancy sensor 31.

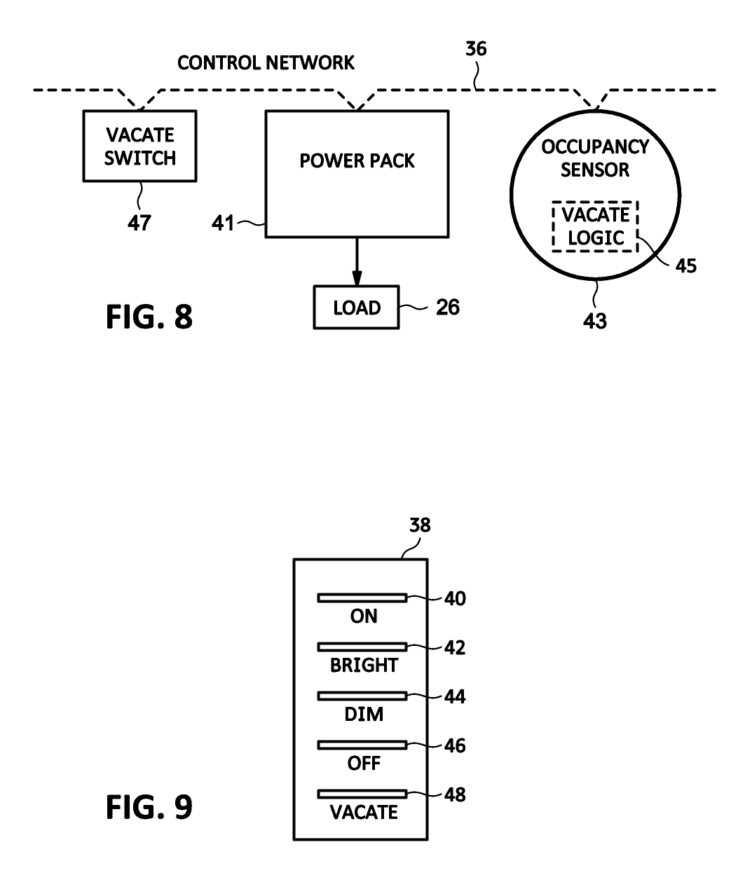

FIG. 8 illustrates another embodiment of an occupancy sensing system according to some inventive principles of this patent disclosure. In the embodiment of FIG. 8, the occupancy sensor 43, power pack 41, and vacate switch 47 are connected to a control network 36, and the vacate switch 47 may be configured to send the vacate input to the occupancy sensor 43 as a command over the network 36. Vacate logic 45 in the occupancy sensor 43 may then clear a delay timer in the occupancy sensor 43 in response to the vacate input. Alternatively, the vacate logic 45 may be located in the power pack 41, vacate switch 47, or any other suitable location on the network 36. Any suitable wired or wireless network may be used to implement the control network 36 including, without limitation, Control Area Network (CAN), LonWorks, Luma-Net, SectorNET, LevNet, etc.

FIG. 9 illustrates a user input device 38 having a vacate input according to some inventive principles of this patent disclosure. The user input device 38 is exemplary shown as a five-button dimming controller. However, it is envisioned that the controller may have more or less buttons. The controller of FIG. 9 is intended for use as a networked input device for a control network such as network 36 shown in FIG. 8. Thus, the embodiment of FIG. 9 may be used to implement the vacate switch 47 shown in FIG. 8. Although the embodiment of FIG. 9 is illustrated in the context of a dimming controller for use with a dimming power pack, the inventive principles are not limited to use with dimming systems.

Referring again to FIG. 9, the controller 38 includes an ON button 40 that, when pressed, causes the lights to fade on to the previously set light level. When pressed and held, a BRIGHT button 42 causes the lights to fade up until the button is released at the desired light level. Similarly, a DIM button 44, when pressed and held, causes the lights to fade down until the button is released at the desired light level. An OFF button 46 causes the lights to fade off when pressed. A press of the OFF button 46 also causes any occupancy sensor that is configured to respond to the dimming controller 38 to reset its DELAY TIMER to the maximum value to prevent the lights from coming back on in response to detecting an occupied state during the delay time. Pressing the VACATE button 48 also causes the lights to fade off, but rather than resetting its DELAY TIMER, it causes any occupancy sensor that is configured to respond to the dimming controller 38 to clear its DELAY TIMER, thereby enabling it to turn the lights back on as soon as occupancy is detected. As with other embodiments described above, the embodiment of FIG. 9 may be configured with a dead time to prevent the lights from being turned back on by movement that is detected as occupants vacate the monitored space.

In an alternative, four-button embodiment, the OFF button 46 may be eliminated and its function replaced by a double press of the DIM button 44, or vice versa. Thus, a double press of the DIM button 44 may be used to turn off the lights while leaving the space, while a single press of the VACATE button 48 may be used to turn off the lights while remaining in the room.

In another alternative, four-button embodiment, the VACATE button 48 may be eliminated but its functionality combined with the OFF button 46, or vice versa. For example, a single press of the OFF button 46 may be used to turn off the lights while remaining in the room, while a double press of the OFF button 46 may be used to turn off the lights while leaving the space, i.e., to generate a vacate input.

Although the embodiments of FIGS. 4-9 are illustrated in the context of systems that use power packs for switching power to a load, the power switching functionality may be realized in any other suitable form including relay cabinets and modules, dimmer racks and modules, wiring devices, etc.

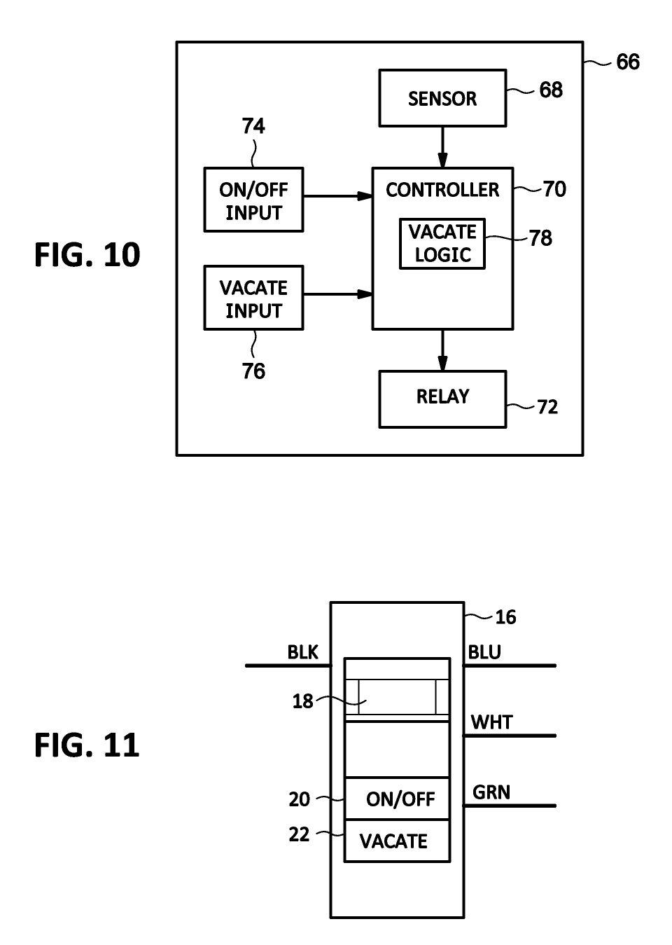

FIG. 10 illustrates another exemplary embodiment of an occupancy sensing system according to some inventive principles of this patent disclosure. The system of FIG. 10 is embodied as a single unit 66 such as a wall switch or other wiring device. It preferably includes a sensor circuit 68 to monitor a space and a controller 70 to control a relay or other power switch 72 in response to input from the sensor circuit 68. The embodiment of FIG. 10 also preferably includes a MANUAL ON/OFF button 74 to enable a user to toggle the state of the relay 72, and a vacate input 76 to enable a user to initiate a vacate sequence. The controller 70 preferably includes vacate logic 78 to implement the vacate sequence and/or other vacate functionality.

FIG. 11 illustrates an exemplary physical embodiment of an occupancy sensing system suitable for implementing the block diagram shown in FIG. 10 according to some inventive principles of this patent disclosure. The embodiment of FIG. 11 is illustrated as a wall switch type of wiring device 16 having, for example, a PIR sensor 18, and BLK, BLU, WHT and GRN wire leads for incoming hot (line), switched hot (load), neutral and ground connections, respectively. The embodiment of FIG. 11 preferably includes a microcontroller-based controller and power switching relay that operate in a conventional manner, but with the inclusion of vacate input functionality according to the inventive principles of this patent disclosure. A MANUAL ON/OFF button 20 causes the controller to toggle the lights or other load on and off in a conventional manner.

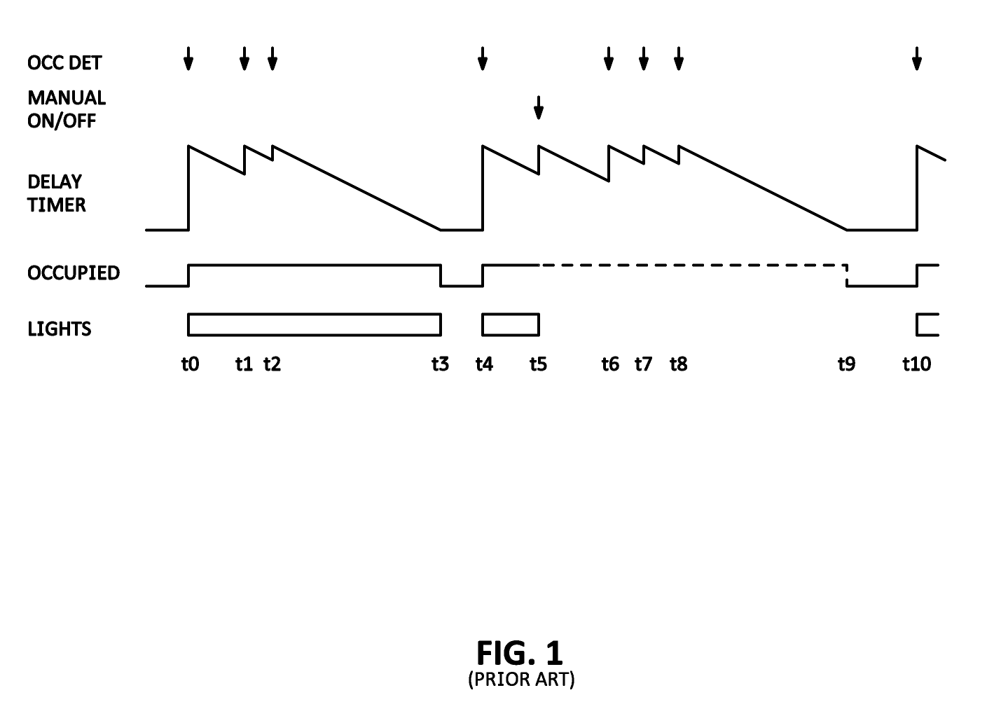

A VACATE button 22 provides a vacate input that causes the controller having vacate logic to perform a vacate sequence in response to a press of the vacate button 22. The vacate sequence may include, for example, de-energizing the load and then clearing DELAY TIMER or setting DELAY TIMER to a value that times out in a few seconds. The system of FIG. 11 may implement, for example, a method similar to that shown in FIG. 2, while still providing the conventional functionality in response to the MANUAL ON/OFF switch as shown in FIG. 1.

In an alternative embodiment, the functions of the MANUAL ON/OFF and VACATE buttons may be combined into a single button. For example, a single press of the combined button may cause the controller to respond by toggling the state of the load as it normally would in response to the MANUAL ON/OFF button. However, a double press (two short presses in rapid succession) of the combined button may cause the controller to perform a vacate sequence as it would in response to a dedicated vacate button, or vice versa.

Some additional inventive principles relate to techniques for determining, in response to a press of a MANUAL OFF button, whether a space has been vacated. Such techniques may be useful, for example, to eliminate the need for two buttons to differentiate between a situation in which an occupant intends to turn off the lights but still remain in a monitored space, and a true vacate situation in which an occupant intends to turn off the lights because the monitored space will be vacant.

One technique for implementing a vacate self-detect method according to some inventive principles of this patent disclosure involves monitoring the space for occupants after a MANUAL OFF button is pressed. During a first relatively short time period after the MANUAL OFF button is pressed, any occupancy detection events are ignored to allow the occupant or occupants to vacate the monitored space. During the next period of time, which may be longer than the first period of time, but not quite as long as the usual time-out delay, if any occupancy detection events occur, it indicates that occupants remain in the space, and the MANUAL OFF button was pressed to force the lights off for, e.g., an audio-visual presentation, and the occupants intend to continue occupying the space with the lights off. Therefore, the occupancy sensor operates normally with the lights remaining off until an entire time-out delay period elapses with no occupancy detected. However, if during the next period of time no occupancy events are detected, it indicates that the space has been vacated. Therefore, the delay timer is cleared, and occupancy sensor will turn the lights back on without significant delay as soon as occupancy is detected again.

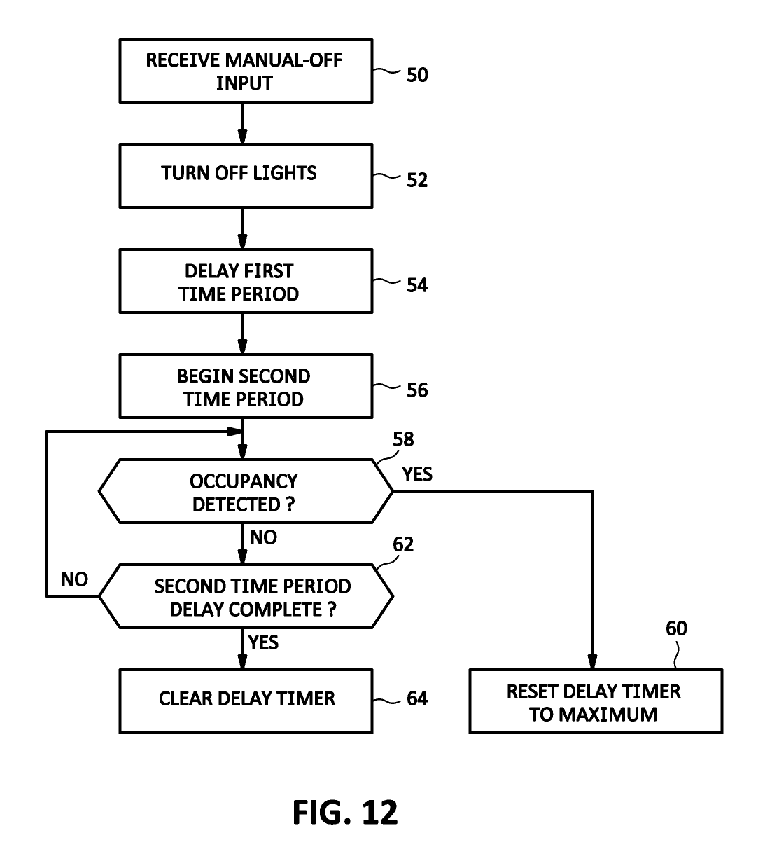

FIG. 12 illustrates an embodiment of such a method according to some inventive principles of this patent disclosure. The method begins at 50 when a MANUAL OFF input is received. The lights are turned off at 52, and the method delays for a first time period, e.g., 2-5 seconds, at 54 to enable any occupants to leave the monitored space. A second time delay, e.g., 5-15 seconds, begins at 56. During the second time delay, the space is monitored for occupancy to determine whether the space has been vacated. At 58, the method determines whether occupancy has been detected. If occupancy has been detected, it indicates that the space is still occupied but the lights should remain off, for example, to accommodate an A/V presentation. Therefore, the DELAY TIMER is reset to its maximum value at 60.

If occupancy is not detected at 58, the method determines whether the second time period is completed at 62. If the second time period is not completed, the method returns to 58 to continue checking for occupancy. If no occupancy is detected at 58, and the second time delay has been completed at 62, it indicates that the space has been vacated. Therefore, the DELAY TIMER is cleared at 64 so the lights can turn back on as soon as occupancy is detected in the space.

A potential benefit of the methodology described in connection with FIG. 12 is that it may eliminate the need for a dedicated vacate button because it may utilize an existing button or other form of input. A further advantage is that it may relieve the user of having to figure out how to provide a vacate input to the system because it may automatically determine the user's intentions. That is, the user may simply press a MANUAL OFF button, and the system may automatically differentiate between the user's intention to force lights off regardless of occupancy, and intention to force lights off until the monitored space is occupied again.

The inventive principles described above with respect to the embodiment of FIG. 12 may be implemented in any suitable manner. For example, code to execute the method may be included in a wall or ceiling mount occupancy sensor, in a wall switch type of occupancy sensor, in a power pack, etc.

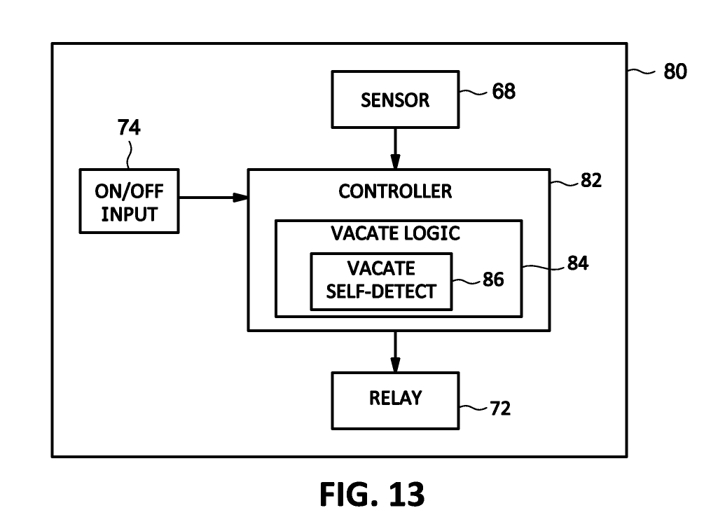

FIG. 13 illustrates another exemplary embodiment of an occupancy sensing system according to some inventive principles of this patent disclosure. The system of FIG. 13 is similar to that of FIG. 10, but the vacate input is eliminated, and vacate self-detect logic 86 is included in the vacate logic 84 within the controller 82. The vacate self-detect logic 86 enables the system of FIG. 13 to implement a method such as the one described and illustrated in FIG. 12, thereby eliminating the need for a dedicated vacate button. The system of FIG. 13 may be embodied, for example, in a manner that is physically similar to that shown in FIG. 4, but without the need for the dedicated vacate switch 22.

The inventive principles of this patent disclosure have been described above with reference to some specific example embodiments, but these embodiments can be modified in arrangement and detail without departing from the inventive concepts. Such changes and modifications are considered to fall within the scope of the following claims.

1. An occupancy sensing system comprising:
an occupancy sensor to sense the occupied state of a space and control a load in response to the occupied state of the space;
a vacate input to enable an occupant to indicate an intention to vacate the space; and
vacate logic to perform a vacate sequence in response to the vacate input.

2. The system of claim 1 where the vacate input comprises a dedicated vacate input.

3. The system of claim 1 where the vacate input comprises a sequence of actions performed on a multi-purpose input.

4. The system of claim 3 where the sequence of actions comprises a double actuation.

5. The system of claim 3 where the multi-purpose input comprises a switch.

6. The system of claim 1 where the vacate input comprises a message received on a communication network.

7. The system of claim 1 where the vacate input comprises a reboot of the system.

8. The system of claim 1 where the vacate sequence comprises switching a load to an unoccupied state.

9. The system of claim 8 where the vacate sequence further comprises decreasing a delay timer in the controller.

10. The system of claim 9 where decreasing the delay timer comprises clearing the delay timer.

11. The system of claim 8 where the vacate sequence further comprises delaying for a time period to allow an occupant to vacate the space.

12. The system of claim 1 where the vacate logic is further adapted to return the load to an occupied state without substantial delay when the space becomes occupied again.

13. The system of claim 1 further comprising a power pack arranged to supply power to the occupancy sensor and switch power to the load in response to the controller.

14. The system of claim 13 further comprising:
a communication network coupled to the power pack; and
an input device coupled to the communication network and adapted to transmit a vacate command to the power pack.

15. The system of claim 14 where the power pack is adapted to temporarily turn off the power supply to the controller in response to the vacate command.

16. An occupancy sensing system comprising:
an occupancy sensor to sense the occupied state of a space and control a load in response to the occupied state of the space;
a manual input to enable an occupant to manually control the load; and
vacate logic to determine, in response to the manual input, if the space has been vacated.

17. The system of claim 16 where the manual input comprises a manual-off input.

18. The system of claim 17 where the manual-off input comprises a switch.

19. The system of claim 16 where the vacate logic is adapted to:
switch the load to an unoccupied state in response to the manual input; and
decrease a delay timer in response to determining that the space has been vacated.

20. The system of claim 16 where the vacate logic is adapted to determine if the space has been vacated by delaying during a first time period to allow an occupant to vacate the space.

21. The system of claim 20 where the vacate logic is adapted to determine if the space has been vacated by monitoring the space during a second time period following the first time period.

22. The system of claim 16 where the vacate logic is adapted to:
switch the load to an unoccupied state in response to the manual input; and
return the load to the occupied state without substantial delay when the space becomes occupied again.

23. A method comprising:
sensing the occupied state of a space;
controlling a load in response to the occupied state of the space;
turning the load off in response to a vacate input; and
turning the load on without substantial delay when the space becomes occupied after turning the load off in response to the vacate input.

24. The method of claim 23 where the vacate input is generated by determining if the space has been vacated in response to a manual-off input.

25. The method of claim 23 where a delay timer is decreased in response to determining that the space has been vacated.
